(19) United States
(12) Patent Application Publication
(10) Pub. No.: US 2007/0215401 A1
(43) Pub. Date: Sep. 20, 2007

(54) Cruise Control System For Motor Vehicles Having An Automatic Shutoff System

(76) Inventors: Goetz Braeuchle, Reichartshausen (DE); Andre Kroehnert, Marbach (DE)

Correspondence Address: KENYON & KENYON LLP, ONE BROADWAY, NEW YORK, NY, 10004, US

(21) Appl. No.: 10/584,230

(22) PCT Filed: Jul. 22, 2004
(86) PCT No.: PCT/DE04/01609

§ 371 Date: May 17, 2007

(30) Foreign Application Priority Data
Dec. 23, 2003 (DE) 103 60 777.3

(51) Int. Cl. B60K 31/00

(52) U.S. Cl. 180/170

(57) ABSTRACT

In a cruise control system for motor vehicles having a stop-and-go function for automatically keeping the vehicle stopped and a shutoff function for automatically shutting off the cruise control system when the brake pedal is being operated, the shutoff function is not operational if predefined conditions are met, including the condition that the velocity is not greater than a predefined shutoff velocity.

### FIELD OF THE INVENTION

The present invention relates to a cruise control system for motor vehicles having a stop-and-go function for automatically keeping the vehicle stopped and a shutoff function for automatically shutting off the cruise control system when the brake pedal is being operated.

### BACKGROUND INFORMATION

German Published Patent Application No. 199 58 120 describes an example of a cruise control system, which has both an ACC (adaptive cruise control) mode and a stop-and-go mode.

In the ACC mode, the velocity of the vehicle is regulated to an intended speed selected by the driver if the road ahead of the host vehicle is free or vehicles traveling ahead are faster or are sufficiently far away. A distance sensor, for example, a radar sensor, allows a vehicle traveling ahead in the host vehicle's lane and other obstacles to be recognized and the velocity to be adapted, if necessary, such that a vehicle immediately traveling ahead is followed at a reasonably safe distance. The ACC mode is provided in general for traveling on superhighways or sufficiently wide highways in the case of free-flowing traffic, i.e., for traffic situations characterized by relatively low dynamics and relatively great vehicle distances.

In contrast, the stop-and-go mode is provided for lower velocities and offers functions which are not available in the ACC mode, in particular the function of automatically braking the host vehicle to a standstill, for example, when approaching a traffic jam. In some arrangements, automatic resumption of travel is also possible under certain conditions if the vehicle traveling ahead also begins moving. These conditions are met, for example, if the host vehicle has been stopped for just a relatively short period, and the object previously followed, i.e., the vehicle traveling ahead, has remained in the positioning range of the distance sensor without interruption. In contrast, under other conditions when the vehicle traveling ahead drives off it may be advisable only to issue a go request to the driver and allow him/her to make the ultimate decision.

The operating mode is selected either automatically or with the help of special operating controls (mode selector buttons) which allow the driver to activate or inactivate either the ACC mode or the stop-and-go mode.

If the driver actively intervenes by operating the brake pedal, it is generally assumed that a situation exists which is not to be controlled using the automatic functions of the controller. For this reason, in conventional cruise control systems, the control function shuts off automatically as soon as the driver operates the brake pedal, so that no conflict may arise between the driver's actions and those of the cruise control system. Consequently, it is impossible to activate the cruise control system as long as the brake pedal is being operated, i.e., operating the brake pedal blocks activation.

### SUMMARY

A cruise control system according to example embodiments of the present invention may provide that it offers the driver increased operating comfort. This may be achieved by making the shutoff function, activated by operating the gas pedal, non-operational at least under certain conditions if the vehicle is stopped or nearly stopped. Because operation of the brake pedal by the driver in this situation will not have the function of decelerating the vehicle to control any hazard situations, and, due to its stop-and-go function, the cruise control system is capable of holding the vehicle at a standstill, yet causing it to automatically resume travel if the traffic situation permits, no safety considerations are counteracted if the cruise control system remains active with the vehicle at a standstill. The driver therefore does not have to manually re-activate the cruise control system if the brake pedal has been operated intentionally or accidentally with the vehicle at a standstill or in the end phase of the automatically controlled stopping sequence.

Example embodiments of the present invention may be used in vehicles having an automatic transmission in which the vehicle must be kept braked at a standstill unless the gear selection lever is in the neutral or park position. If the cruise control system shuts off, the driver must keep the brake pedal depressed to keep the vehicle at a standstill. Using example embodiments of the present invention, the cruise control system is prevented from shutting down and therefore the vehicle is prevented from accidentally being set in motion if the driver has operated the brake pedal accidentally or unintentionally.

The shutoff function may become non-operational when the vehicle is actually stopped, i.e., when the velocity is exactly 0. The shutoff function may become non-operational whenever the velocity of the vehicle is not greater than a predefined shutoff velocity, which may be on the order of 3 km/hr.

The shutoff function may not be inactivated until the vehicle has been stopped for a certain period of time. The driver thus retains the option of inactivating the cruise control system using the brake pedal, as in the driving operation, by operating the brake pedal while the vehicle is stopping or shortly thereafter.

Typically the stop-and-go function is arranged to have a plurality of different standstill states. When the vehicle has been braked automatically into a standstill by the cruise control system, for example, because the vehicle traveling ahead has stopped, the system first goes into an active standstill state, from which the vehicle is set in motion again automatically, without the driver's intervention, when the vehicle traveling ahead starts moving again. After a longer stop, however, the system goes into a wait state in which motion may only be resumed via an action of the driver, for example, by confirming a go instruction issued by the system. When the shutoff function is inactivated and the brake pedal is operated, the cruise control system may enter the wait state, rather than the active standstill state.

In the instance in which the shutoff function is not inactivated until a certain vehicle standstill period has elapsed, this standstill period should not be shorter than the dwell time during which the cruise control system remains in the active standstill state. If the driver operates the brake pedal after this time has elapsed, the cruise control system remains active; however, it is not in the active standstill state, which allows automatic resumption of travel without driver confirmation, but rather in the wait state in which only a go instruction is issued.

Under the same conditions under which the automatic shutoff function is non-operational, the activation block may also be deactivated such that the cruise control system may be re-activated even at a standstill with the brake pedal depressed.

The automatic shutoff function does not need to be fully deactivated when the brake pedal is operated, but it may be modified such that the cruise control system is automatically shut off only when the driver has held the brake pedal depressed for longer than a certain braking period (for example, 5 seconds) and/or when the braking force exerted by driver or the gradient of the brake pedal operation exceeds a certain minimum value. Thus, the driver has the option, as previously, of inactivating the cruise control system with the aid of the brake pedal, however, without the danger that the cruise control system, which automatically holds the vehicle at a standstill, is unintentionally inactivated because the driver has accidentally touched the brake pedal. If the system is shut off due to braking pressure and/or the braking time, the driver should receive an instruction, for example, in the form of a warning tone, so that the driver is continuously informed whether the cruise control system continues to be active or whether the driver must hold the vehicle at a standstill using the brake pedal.

Optionally, the system may also be shut off when the brake pedal is operated multiple times within a predefined time period (t=tₘᵢₙ−∞).

Exemplary embodiments of the present invention are illustrated in the appended Figures and explained in greater detail in the description that follows.

### BRIEF DESCRIPTION OF THE DRAWINGS

FIG. 1 is a block diagram of a cruise control system and associated control and display elements.

FIG. 2 illustrates a mode of operation of the cruise control system.

FIG. 3 is a flow chart illustrating an exemplary embodiment.

### DETAILED DESCRIPTION

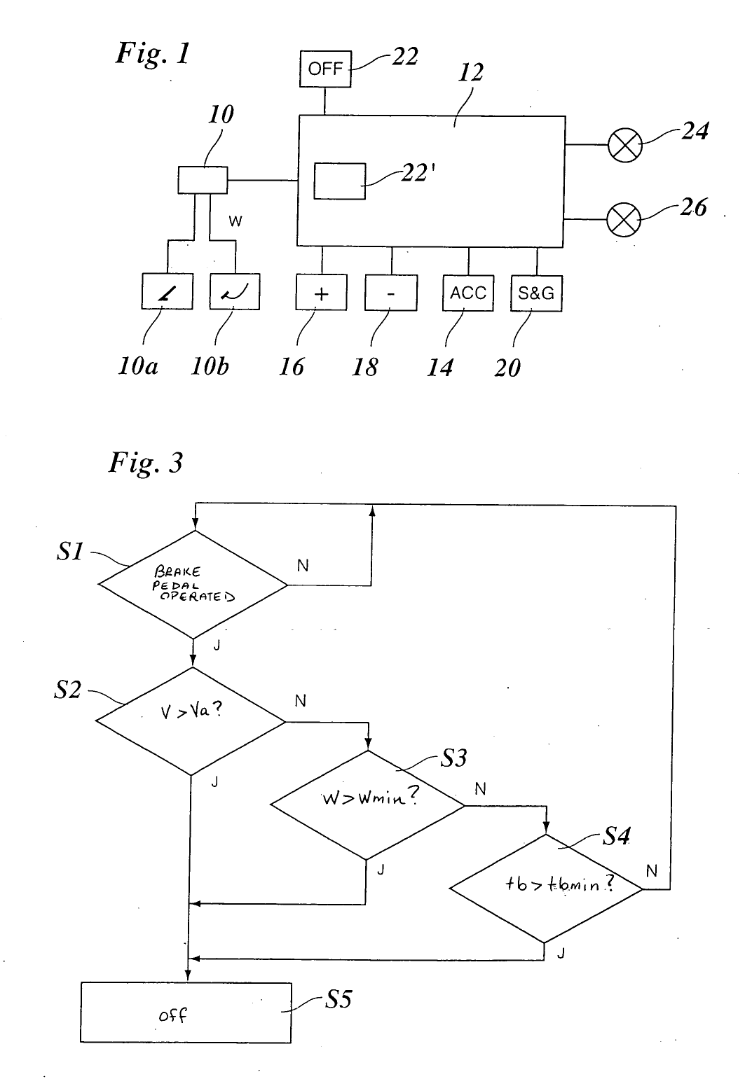

Since the design and mode of operation of certain cruise control systems having ACC and stop-and-go function are conventional, FIG. 1 only illustrates certain components in a block diagram. A sensor device 10 includes a distance sensor, for example, a radar sensor, which measures the distance and relative velocity of a vehicle traveling ahead. If multiple target objects are detected by the radar sensor, for example, multiple vehicles or stationary targets such as road signs, etc., one target object is selected by plausibility analysis among other things.

Conventional sensors, e.g., pedal sensors for a gas pedal 10a and a brake pedal 10b, as well as, for example, a driving velocity sensor, acceleration sensors for detecting the longitudinal acceleration and transverse acceleration, a yaw rate sensor, etc., which are present in the vehicle anyway and whose signals are also used for other control purposes, are also part of sensor device 10. The signals of the distance sensor and the other sensors are analyzed in an electronic control unit 12, which is formed by a microcomputer, for example. Control unit 12 also affects the drive system and brake system of the vehicle to regulate the driving velocity either to an intended velocity selected by the driver or to a suitable distance to the vehicle traveling ahead.

This control function, also referred to as an ACC function, is activated by the driver by operating an ACC button 14. If an intended velocity has previously been saved, the operation of the ACC button has the function of resuming the regulation to this intended velocity. Otherwise, the intended velocity is set by the driver briefly operating a button 16 after the vehicle has reached the intended velocity. Repeated or continuous operation of button 16 causes the intended velocity to increase stepwise. Similarly, operation of a button 18 causes the intended velocity to decrease stepwise.

The ACC function shuts off automatically as soon as the velocity of the vehicle drops below a certain value V₁ of 40 km/hr, for example. As soon as the velocity is below a higher value V₂, which may be 50 km/hr, for example, the driver may activate a stop-and-go function by operating an S&G button 20. The driver will make use of this option, for example, when the vehicle approaches a traffic jam. The stop-and-go function then causes the vehicle to automatically stop at a suitable distance from the traffic jam. If the vehicle stopped in front of the host vehicle moves forward a little, the stop-and-go function causes the host vehicle to automatically start moving and move a similar distance forward. The velocity of the host vehicle is automatically limited to velocity V₂ or a lower intended velocity selected by the driver with the aid of buttons 16 and 18.

The stop-and-go function may be provided such that it provides only automatic braking of the vehicle to a standstill and holding the vehicle at a standstill, but no automatic resumption of travel. An arrangement in which the transitions between the ACC and stop-and-go functions are controlled automatically as a function of the vehicle velocity is also possible.

The ACC and stop-and-go functions may be shut off using an off button 22.

Buttons 14, 16, 18, 20, and 22 may be integrated into a multifunction lever, for example, which may be arranged on the steering wheel of the vehicle, for example.

Pilot lamps 24 and 26 inform the driver about the instantaneous state of the ACC and stop-and-go functions. When pilot lamp 24 is on and is yellow, it means that the ACC function is not active, but may be activated under the given conditions with the aid of ACC button 14. A color switch to green indicates the active state of the function. The same applies to pilot lamp 26 and the stop-and-go function.

As long as the vehicle is rolling, for example, at a velocity of at least 2 to 4 km/hr, a shutoff function 22′ integrated into control unit 12 makes sure that the operation of brake pedal 10b has the same effect as the operation of off button 22, i.e., inactivation of the ACC or stop-and-go function. As long as the driver keeps operating brake pedal 10b, these functions may not be activated using button 14 or 20 (activation block).

However, when the vehicle is almost stopped, i.e., when its velocity is less than or equal to a predefined shutoff velocity Va on the order of 2 to 4 km/hr, operation of brake pedal 10b does not have the same function as the operation of off button 22, but the cruise control system, e.g., the stop-and-go function, remains active. Under these conditions it is also possible to activate the stop-and-go function with the aid of S&G button 20 even while the brake pedal is being operated if this function was previously inactive.

When the cruise control system is inactive, this means, at least for a vehicle having automatic transmission, that the driver must keep brake pedal 10b depressed to hold the vehicle at a standstill. If brake pedal 10b had the effect of an activation block even with the vehicle at a standstill, the stop-and-go function could not be activated at all when the vehicle is at a standstill. Due to the fact that in the cruise control system described herein shutoff function 22′ and the activation block are non-operational if the velocity is less than shutoff velocity Va, the vehicle is prevented from starting to roll unexpectedly for the driver. The driver is also given the option of activating the cruise control system with the vehicle stopped.

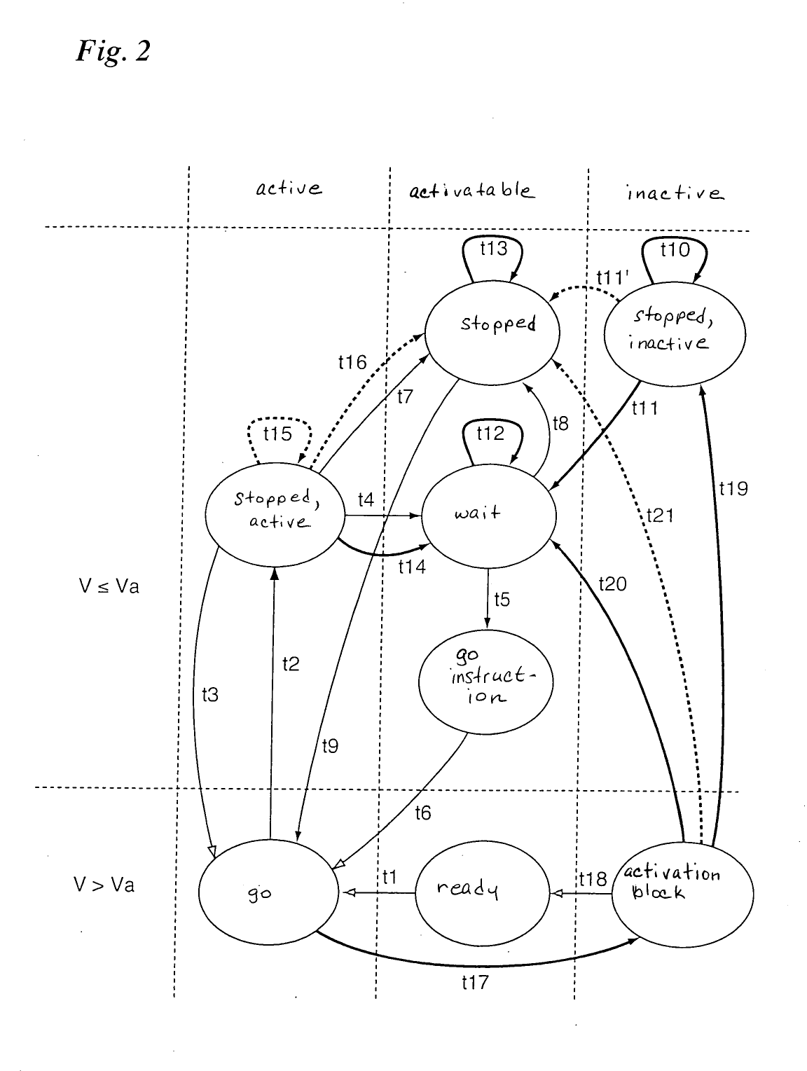

The functions of the cruise control system, are explained in detail with reference to a state diagram illustrated in FIG. 2. Each ellipse illustrated in FIG. 2 symbolizes a state of the cruise control system, and arrows between the individual ellipses represent transitions between the corresponding states. The solid arrows symbolize transitions which are possible while brake pedal 10b is being operated. Arrows represented only as thin lines and having white-filled arrow heads symbolize transitions which are not possible while the brake pedal is being operated. The states are shown in a table having the columns “active,” “activatable,” and “inactive,” and lines “V≦Va” and “V>Va.” For the sake of simplicity, only those states related to the stop-and-go function are shown. The stop-and-go function is active in the states of the “active” column. In the states of the “activatable” column, the function is not, or not fully, active, but may be activated. The stop-and-go function is inactivated in the states of the “inactive” column. States in the “V>Vₐ” line may only exist when velocity V of the vehicle is greater than shutoff velocity Va. The states in the “V≦Va” line may occur when the vehicle is almost stopped.

When the vehicle is traveling at a velocity of 25 km/hr, for example, and the cruise control system is not active, the system is in the “ready” state. By operating button 20, the driver may then activate the stop-and-go function, and the system goes into the “go” state according to arrow t1. If there is a target object, i.e., a vehicle traveling ahead, this vehicle is followed at a reasonable distance. When the target object stops, the vehicle equipped with the cruise control system is automatically braked to a stop corresponding to a transition according to arrow t2 to the “stopped, active” state. In this state, the vehicle brake is held automatically by the cruise control system, so that the vehicle remains stopped. The system remains in the “stopped, active” state for a predefined dwell time. If the target object starts moving again within this dwell time, the host vehicle is automatically set into motion, and the system resumes the “go” state according to arrow t3.

If the dwell time has elapsed in the “stopped, active” state, but the target object is still there, the system goes into a “wait” state according to arrow t4. The vehicle may start moving again from this state only upon driver confirmation. If the target object starts moving again, a transition into the “go instruction” state occurs via arrow t5, and a go instruction is issued to the driver, for example, in the form of an acoustic signal. When the driver then confirms the intention to “go” within a predefined time interval, for example, by operating S&G button 20, or button 16, or gas pedal 10a, the vehicle starts moving automatically, and the cruise control system goes into the “go” state again according to arrow t6.

If the target object is lost in the “stopped, active” or “wait” state, a transition from the “stopped” state occurs according to arrow t7 or t8, a transition to the “go” state is only possible again by operating the gas pedal (arrow t9).

When off button 22 is operated in the “go” state to inactivate the cruise control system, the system goes into the “ready” state (not represented by any arrow). If in one of the states where the vehicle is almost stopped off button 22 is operated, the system goes into the “stopped, inactive” state. At the same time, an acoustic instruction is issued for the driver to operate the brake pedal in order to hold the vehicle at a standstill. Operation of the brake pedal, which in itself does not result in exiting from this state, is symbolized by an arrow t10. Because the activation block is not operational in this state, the driver may press S&G button 20 even while operating the brake pedal to go into the “wait” state according to arrow t11. Alternatively, the operation of button 20 may also cause a transition into the “stopped” state (arrow t11′). However, transition into the “wait” state has the advantage that the driver receives a go instruction when the vehicle traveling ahead starts moving. If there is no target object, the system returns into the “stopped” state via arrow t8. If the brake pedal is operated (arrows t12 and t13) in one of the states “wait” or “stopped,” this does not result (unlike the operation of off button 22) in a return to the “stopped, inactive” state, but the system remains in its particular state.

If the brake pedal is operated in the “stopped, active” state, a transition according to arrow t14 to the “wait” state may occur. However, alternatively, the system may also remain in the “stopped, active” state (arrow t15) or go into the “stopped” state (arrow t16).

If the brake pedal is operated in the “go” state, a transition according to arrow t17 to the “activation block” state occurs, and the cruise control system is inactivated. As long as the brake pedal is depressed, the stop-and-go function may not be re-activated during travel. No transition to the “ready” state, in which the cruise control system may be re-activated, occurs according to arrow t18 until the driver releases the brake pedal

If the driver holds the brake pedal depressed in the “activation block” state, the velocity ultimately drops below Vₐ, and a transition to the “stopped, inactive” state according to arrow t19 occurs without any additional action by the driver. After the velocity has dropped below Va, the driver may still depress S&G button 20 even while keeping the brake pedal depressed, thus causing the system to immediately go into the “wait” state (arrow t20) or, according to a possible alternative, into the “stopped” state (arrow t21).

Possible variants of the above-described arrangement are briefly presented below with reference to FIG. 2.

Shutoff velocity Va may also have the value 0. In this instance, the activation block and the shutoff function of the brake pedal are operational only if the vehicle is actually stopped.

According to another modification, the activation block and the shutoff function of the brake pedal remain operational during a certain delay period after the system has gone into the “stopped, active” state according to arrow t2 and the vehicle has come to a standstill. This delay period may be of the same length as the dwell time during which the system remains in the “stopped, active” state.

As a result, transitions t15 and t16 are not possible, but instead, when the brake pedal is operated, the system goes from the “stopped, active” state into the “stopped, inactive” state (shutoff function of the brake pedal). Only when the brake pedal is operated after the system has gone into the “wait” state according to arrow t4 does the shutoff function become non-operational, and the system remains in the “wait” state according to arrow t12.

The delayed cancellation of the shutoff function and of the activation block also results in only a transition into the “stopped, inactive” state according to arrow t19 being possible from the “activation block” state, but not a direct transition into the “wait” state according to arrow t20. The transition from the “stopped, inactive” into the “wait” state according to arrow till is also only possible in this case when the vehicle has been stopped for a period of time equal to the delay period.

In the above-described exemplary embodiments, operation of brake pedal 10b in the “wait” and “stopped” states and possibly also in the “stopped, active” state does not have the same function as operation of off button 20, i.e., it does not result in inactivation of the cruise control system. However, the cruise control system may be optionally modified such that, in the states in which the velocity is less than or equal to Va, the duration of the brake pedal operation is measured and the cruise control system is inactivated if the duration of operation exceeds a certain threshold value. In that instance, the activation block is also operational as long as the brake pedal is kept depressed. Alternatively, the condition for inactivation of the cruise control system and for making the activation block operational may be the operating force or the path of the brake pedal exceeding a certain threshold value. Suitable combinations of these conditions are also possible.

FIG. 3 illustrates an arrangement in which the duration of the operation of brake pedal 10b and the length of brake pedal path W are checked within shutoff function 22′.

In step S1 it is cyclically checked whether the brake pedal is being operated. If operation of the brake pedal has been determined (J), a timer is triggered, and it is checked, in step S2, whether velocity V of the vehicle is greater than shutoff velocity Va. If this is not the case, i.e., when the vehicle is almost stopped, it is further checked, in step S3, whether the pedal path is greater than a certain threshold value Wmin. If this is also not the case, it is checked in step S4, with the aid of the timer, whether the duration of operation tb of the brake pedal is greater than a certain threshold value tbmin. If this condition is also not met, the procedure jumps back to step S1, and the cruise control system remains active until further action. Only in the event of a positive result in one of steps S2, S3, and S4, does the procedure branch off to step S5, and the shutoff function is triggered.

1-9. (canceled)

10. A cruise control system for a motor vehicle, comprising:
a stop-and-go function adapted to automatically keep the vehicle stopped;
a shutoff function adapted to automatically shut off the cruise control system when a brake pedal is being operated, the shutoff function non-operational if predefined conditions are met, including a condition that a velocity is not greater than a certain shutoff velocity.

11. The cruise control system according to claim 10, wherein the shutoff velocity is equal to 0.

12. The cruise control system according to claim 11, wherein a condition for the shutoff function being non-operational is a lapse of a predefined time interval since a standstill of the vehicle.

13. The cruise control system according to claim 10, wherein the shutoff velocity is greater than 0 but less than 10 km/hr.

14. The cruise control system according to claim 10, wherein under the conditions under which the shutoff function is non-operational, the cruise control system is activatable by an operating control even while the brake pedal is being operated.

15. The cruise control system according to claim 10, wherein the stop-and-go function includes a stopped, active state in which the vehicle is settable in motion without driver intervention, and at least one wait state in which start of motion of the vehicle is resumable only upon driver confirmation, and, if the predefined conditions are met, the cruise control system is adapted to enter the wait state at least one of (a) upon operation of the brake pedal in the active state and (b) when activated with the brake pedal being operated.

16. The cruise control system according to claim 10, wherein the shutoff function becomes operational, even if the predefined conditions are met, by the brake pedal being operated for a period longer than a predefined minimum period.

17. The cruise control system according to claim 10, wherein the shutoff function becomes operational, even if the predefined conditions are met, by the brake pedal being operated multiple times within a predefined time interval.

18. The cruise control system according to claim 10, wherein the shutoff function becomes operational, even if the predefined conditions are met, by one of (a) an intensity and (b) a gradient of brake pedal operation exceeding a predefined minimum value.
